(19) United States
(12) Patent Application Publication
(10) Pub. No.: US 2014/0378026 A1
(43) Pub. Date: Dec. 25, 2014

(54) APPARATUS AND METHOD FOR SHAPING AND EXTRUDING FORMABLE MATERIAL

(71) Applicant: Hasbro, Inc., Pawtucket, RI (US)

(72) Inventors: Mark Foster, Cumberland, RI (US); Michael DiPalma, Pawtucket, RI (US); Douglas A. Schultheis, Cumberland, RI (US)

(21) Appl. No.: 13/922,028

(22) Filed: Jun. 19, 2013

(51) Int. Cl. A63H 33/00; B29C 43/32; B29C 43/04; A63H 17/05; A63H 17/26

(52) U.S. Cl. CPC A63H 33/001; A63H 17/05; A63H 17/266; B29C 43/04; B29C 43/32; B29C 2043/043; B29C 2043/3294
USPC 446/448; 425/62; 425/237

(57) ABSTRACT

A toy recycling truck that shapes and extrudes formable material is described. A formable material is fed into a first opening, or door, on the top of the truck and is extruded out of a second opening at the back of the truck. The formable material is fed into a molding extruder having a molding device and an expeller. The molding device includes a first cylindrical roller and a second cylindrical roller with inset molds that are adjacent and that turn toward each other so that the formable material fills the molds with pushed into the molding device. A three dimensional figure is released from the molds and synchronized to be extruded by an expeller. The expeller includes a paddle wheel with one or more paddles that extrudes the three dimensional shape molded from the formable material.

### FIELD OF THE INVENTION

The present invention relates generally to a shaper and extruder of formable material, and more particularly to a toy vehicle that receives formable material into three dimensional molds in one part of the vehicle and extrudes a molded object out another part of the vehicle. For example, a toy recycling truck receives formable material into three dimensional molds through the dumping area on the top of the truck, and the molds release the shaped object into an extruder that expels the shaped object through an opening in the back of the truck.

### BACKGROUND OF THE INVENTION

Children love playing with toy vehicles, and toy trucks are especially popular. Children often entertain themselves by rolling a toy truck along a playing surface, making noises that emulate a real truck and imagining themselves as part of a real-life situation involving a real truck. A child's play experience is enhanced when the toy truck performs other functions besides rolling or when the toy truck fits a certain theme. For example, U.S. Pat. No. 6,264,528 B1, issued to Doan et al., for “Remote-Controlled Toy Trash Truck”, issued Jul. 24, 2001, discloses a remote-controlled toy trash truck with a trash bin mounted on the frame member and a load-lifting arm operably connected to the frame member and capable of lifting items for placement into the trash-holding bin. Additionally, toy truck play may also involve a theme and activities unrelated to the operation of a real truck. U.S. Pat. No. 5,366,227, issued to Duffy, for “Recycling Game”, issued Nov. 22, 1994, discloses a recycling game apparatus including a toy vehicle having a plurality of bins for holding game pieces and having a card caddy thereon. A deck of cards is supported in the toy vehicle card caddy along with a plurality of game pieces with each game piece having a shape emulative of a recycling member and stored in a marked bin. The game pieces can be moved into and out of the bins in playing the game. Each card in the deck of cards has information concerning one recycling item which is emulative of at least one game piece, such as aluminum, newspaper, glass, or plastic. Each toy vehicle plurality of bins may be marked with indicia to indicate aluminum, paper, glass, plastic, or trash. The toy vehicle is used to store the game with cards and pieces as well as used in playing the game.

Another favorite activity of children is playing with modeling compounds, such as clay. Apparatus and methods of various sophistication are known for forming modeling compound materials such as the popular PLAY-DOH™ formable material, colored plastic material, Plasticine™, modeling clay or the like. Such modeling compounds and the like are used by children to form a variety of shapes, articles or artwork. Modeling compounds may be molded with tools, by hand or by molds. Additionally, extrusion and template apparatus may be used. Children typically use such apparatus to fashion modeling compounds into a wide variety of desirable shapes, for example, animals, flowers, artwork or to form fanciful designs and the like.

Certain mechanisms have been employed for shaping, forming, or molding and extruding such modeling compounds and are also known in the prior art. U.S. Pat. No. 4,569,815, issued to Rentz et al., for “Method and Device for Simultaneously Propelling and Forming Impressions with a Flowable Material”, issued Feb. 11, 1986, discloses a toy for extruding and molding various predetermined shapes of modeling compound or the like. In the Rentz et al. apparatus, a lever moves a piston to force the modeling compound either through an extrusion mold or into a mold cavity to form the desired shapes. Pushing a modeling compound through an extrusion mold by rotating a screw-like device is also known in the prior art. U.S. Pat. No. 6,602,066, issued to Heayes, for “Extruder for Formable Materials”, issued Aug. 5, 2003, discloses a chamber with first and second openings and an extruder received at the second opening with a die coupled to the first opening. The extruder advances longitudinally through the chamber relative to the die. Rotation of the extruder causes the chamber and contained formable compound received therein to rotate relative to the die. Advancement of the extruder forces the rotating formable compound through the die.

Shaping, forming, or molding such modeling compounds or altering the form of other shapeable substances have also been accomplished using rotors or rollers. U.S. Pat. No. 5,314,373, issued to Caveza et al., for “Toy Food Processor and Simulated Oven”, issued May 24, 1994, discloses a toy food grinder including a pair of parallel rollers and handle crank mechanism. The food grinder receives a brittle food material such as crackers or the like that is converted or crushed to a particulate material as the rollers are rotated and the food article is inserted between the rollers. The crushed particulate food material is accumulated on a tray and manually formed into shaped food articles. U.S. Pat. No. 6,851,192, issued to So, for “Pastry Cutter”, issued Feb. 8, 2005, discloses a rotor having a central axis and a periphery around the axis with a plurality of cutting molds individually connected to the periphery, such that generally flat cup-shaped bodies lie in an annular arrangement around the rotor with cutting rims facing outwards. Each stem has an outer end connected to the corresponding body and an inner end releasably connected to the periphery.

While there is a great variety of toy trucks and a great variety of molds and extruders for formable compounds, the prior art does not disclose an extruder housed within a toy vehicle whereby a formable compound is inserted into a first opening in the housing of the toy vehicle, and, as the vehicle moves, the formable compound is molded into a three-dimensional shape and extruded or expelled from a second opening. Accordingly, it would be desirable to provide a toy vehicle with structure modeling compound recycling and recirculating features, for example, a recycling truck with a bin that collects unformed formable material or pre-formed formable material, such as bottles and cans, and reforms and extrudes out the back of the truck newly molded shapes, such as fish bones, mice and insects. Thus, children will have increased enjoyment with the combination of toy vehicles and a molding extruder that is unknown in the prior art. The inventions discussed in connection with the described embodiment address these and other deficiencies of the prior art.

The features and advantages of the present inventions will be explained in or apparent from the following description of the preferred embodiment considered together with the accompanying drawings.

### SUMMARY OF THE INVENTION

The present inventions address the deficiencies of the prior art of toy vehicle play and the prior art of molding and extruding formable compounds such as Play-Doh™ and the like by presenting a toy truck that receives a formable compound into a mold through a first opening of the vehicle, forms a three dimensional figure with the formable compound, and extrudes the figure through a second opening of the vehicle. Thus, the excitement of toy vehicle play and playing with formable compounds will be increased.

More particularly, the present inventions include an apparatus for shaping and extruding formable material. The apparatus uses a first cylindrical roller adjacently aligned to a second cylindrical roller, each roller rotatable toward the other and having symmetrically aligned molds inset into the first cylindrical roller and the second cylindrical roller. The molds are positioned to receive and form a formable material into a three-dimensionally shaped object when rotated and fed the formable material. The molds release the object formed from the formable material in the common direction of the rotatable rollers when the symmetrically aligned molds separate during rotation. A rotatable paddle wheel having one or more paddles is aligned so that as the paddle wheel rotates, the one or more paddles are juxtaposed where the rotatable rollers separate from the symmetrically aligned molds and release the object formed from the formable material. The first cylindrical roller, the second cylindrical roller and the paddle wheel are in mechanical communication with and synchronized by a gear mechanism so that the one or more paddles extrude the object formed from the formable material in the tangential direction of the rotation of the paddle.

Described embodiments of the apparatus for shaping and extruding formable material include a housing surrounding the first cylindrical roller, the second cylindrical roller, the symmetrically aligned molds, the paddle wheel and the gear mechanism, and in some of the described embodiments, the housing is in the shape of a toy truck. The housing may have compartments for holding three-dimensional book molds for shaping the formable material. Described embodiments of the apparatus further have a chassis with one or more wheels in mechanical communication with the gear mechanism such that movement initiated in the one or more wheels causes movement in the gear mechanism, the first cylindrical roller, the second cylindrical roller, the symmetrically aligned molds and the paddle wheel. Thus, in the case of an embodiment of a toy truck, when the truck is rolled, the parts inside the housing will move.

In some described embodiments, the first cylindrical roller, the second cylindrical roller and the symmetrically aligned molds are exposable through a first opening in the top of the housing and the paddle wheel is exposed through a second opening in the back of the housing. A door covering the first opening may be used so that when the first opening is filled with the formable material and the door is closed, the formable material is pushed between the first cylindrical roller and the second cylindrical roller. Thus, when the rollers move, the molds will fill and form three dimensional objects. A bin may be rotatably connected to the housing such that it may be filled with formable material and rotated to drop the formable material into the first opening.

As a safety feature in the described embodiments, the door covering the first opening in the top of the housing is in mechanical communication with the gear mechanism such that when the door is closed and covers the first opening, the first cylindrical roller and the second cylindrical roller rotate in response to movement of the gear mechanism, and when the door is open, the first cylindrical roller and the second cylindrical roller do not rotate. In some of these embodiments, the gear mechanism has a first gear rotatably connected to the first cylindrical roller, a second gear rotatably connected to the second cylindrical roller and engaged with the first gear, a third gear rotatably connected to a wheel and aligned in the same vertical plane as the first gear and the second gear, and a fourth gear engageably situated between the second gear and the third gear. A support is attached to the fourth gear and moveably mounted to either the second cylindrical roller or the housing so that the support may be moved to engage and to disengage the fourth gear from the second gear and the third gear. A lever is pivotably mounted to the housing so that when the door is closed, the lever pivots into the support and engages the fourth gear with the second gear and the third gear, and when the door is open, the lever retreats from the support, moving the support and disengaging the fourth gear from the second gear and the third gear.

The present inventions further include a toy truck that shapes and extrudes formable material having a housing, a first opening in the housing, and a second opening in the housing. The toy truck includes a molding extruder having a molding device and an expeller. The molding device is mounted within the housing and accessible through the first opening. The molding device also has an entry that receives a formable material, a mold in communication with the entry that receives and shapes the formable material into a three-dimensional object and an exit in communication with the mold that releases the three-dimensional object. The expeller, in communication with the exit of the molding device, receives the three-dimensional object and expels it through the second opening. The toy truck may have a bin rotatably connected to the housing such that it may be filled with a formable material and rotated to drop the formable material into the first opening. The housing may have compartments for holding three-dimensional book molds for shaping the formable material.

In embodiments of the toy truck, the molding device in the molding extruder may further have a first cylindrical roller adjacently aligned to a second cylindrical roller, each roller rotatable toward the other and having symmetrically aligned molds inset into the first cylindrical roller and the second cylindrical roller. The molds are positioned to receive and form a formable material into a three-dimensionally shaped object when rotated and fed the formable material. The molds release the object formed from the formable material in the common direction of the rotatable rollers when the symmetrically aligned molds separate during rotation. The expeller in the molding extruder may further have a rotatable paddle wheel having one or more paddles. The paddle wheel is aligned so that as the paddle wheel rotates, the one or more paddles are juxtaposed where the rotatable rollers separate from the symmetrically aligned molds and release the object formed from the formable material. The first cylindrical roller, the second cylindrical roller and the paddle wheel are in mechanical communication with and synchronized by a gear mechanism so that the one or more paddles extrude the object formed from the formable material in the tangential direction of the rotation of the paddle. Embodiments of the toy truck have a chassis having one or more wheels in mechanical communication with the gear mechanism such that movement initiated in the one or more wheels moves the gear mechanism and activates the molding extruder.

In some embodiments of the toy truck, a door covering the first opening may be attached so that the door pushes formable material into the molding device upon closing. The door may also be used as a safety feature. The door covering the first opening may be in mechanical communication with the gear mechanism such that when the door is closed the gear mechanism engages the molding device and allows the molding device to mold the formable material, and, when the door is open, the gear mechanism disengages from the molding device and prevents the molding device from shaping the formable material. In some of these embodiments, the gear mechanism has a first gear rotatably connected to the molding device, a second gear rotatably connected to the molding device and engaged with the first gear, a third gear rotatably connected to a wheel and aligned in the same vertical plane as the first gear and the second gear, and a fourth gear engageably situated between the second gear and the third gear. A support is attached to the fourth gear and moveably mounted to either the molding device or the housing so that the support may be moved to engage and disengage the fourth gear from the second gear and the third gear. A lever is pivotably mounted to the housing so that when the door is closed, the lever pivots into the support and engages the fourth gear with the second gear and the third gear, and when the door is open, the lever retreats from the support and the support moves and disengages the fourth gear from the second gear and the third gear.

The present inventions also provide for a method of using a toy truck to shape and extrude formable material. The method includes aligning a first cylindrical roller adjacent to a second cylindrical roller, each roller rotatable toward the other, insetting molds into the first cylindrical roller and the second cylindrical roller, symmetrically aligning the molds to receive and form a formable material into a three-dimensionally shaped object, aligning a rotatable paddle wheel having one or more paddles so that as the paddle wheel rotates the one or more paddles are juxtaposed where the rotating rollers separate from the symmetrically aligned molds and release the object formed from the formable material, synchronizing the movement of the first cylindrical roller, the second cylindrical roller and the paddle wheel using a gear mechanism, and encasing the first cylindrical roller, the second cylindrical roller, the molds, the paddle wheel and the gear mechanism in a toy truck shaped housing with a first opening and a second opening so that the first cylindrical roller, the second cylindrical roller and the molds are exposed through the first opening and the paddle wheel is exposed through the second opening, attaching a chassis with wheels to the housing and attaching at least one of the wheels to the gear mechanism such that movement initiated in the one or more wheels causes movement in the gear mechanism, the first cylindrical roller, the second cylindrical roller, the symmetrically aligned molds and the paddle wheel, rotating the first cylindrical roller and the second cylindrical roller by rolling the toy truck, feeding formable material between the rotating rollers and forming the object in the molds, releasing the object formed from the formable material in the common direction of the rotatable rollers when the symmetrically aligned molds separate during rotation, and extruding the object formed from the formable material in the tangential direction of the rotation of the paddle. The method further includes attaching a door to the first opening, opening the door and exposing the molds, disengaging the gear mechanism, feeding formable material into the molds, closing the door, engaging the gear mechanism when the door is closed, rolling the truck, and extruding three-dimensionally shaped objects.

### BRIEF DESCRIPTION OF THE DRAWINGS

The inventions will now be more particularly described by way of example with reference to the accompanying drawings. Novel features believed characteristic of the inventions are set forth in the claims. The inventions themselves, as well as the preferred mode of use, further objectives, and advantages thereof, are best understood by reference to the following detailed description of the embodiment in conjunction with the accompanying drawings, in which:

FIG. 1 shows a side elevation view of a toy recycling truck and recyclable figures made from a formable material.

FIG. 2 shows a side elevation view of the toy recycling truck with the top door open and the recycle bin moving towards truck's storage bin.

FIG. 3 shows an overhead view the toy recycling truck with the first cylindrical roller and the second cylindrical roller moving and with the recycle bin rotating toward the truck's storage bin.

FIG. 4 shows an overhead close up view of symmetrically aligned molds inset into the first cylindrical roller and the second cylindrical roller.

FIG. 5 shows a side elevation view of the toy recycling truck with the storage bin filled with recyclable figures made from a formable material.

FIG. 6 shows a side elevation view of the toy recycling truck extruding molded objects from the back of the truck.

FIG. 7 shows a bottom perspective view with the paddle wheel extruding the molded objects.

FIG. 8 shows a perspective view of the connections between the first cylindrical roller, the second cylindrical roller, the gear mechanism, the paddle wheel, the door, and the door-triggered safety feature.

FIG. 9A shows a close up view of the interaction between the gear mechanism and the door-triggered safety feature with the door closed and the gears engaged.

FIG. 9B shows a close up view of the interaction between the gear mechanism and the door-triggered safety feature with the door open and the gears disengaged.

### DETAILED DESCRIPTION OF THE EMBODIMENTS

The described embodiment is a toy recycling truck that collects formable material, such as Play-Doh™, in a storage bin on the top of the truck, and, as the truck is rolled on a playing surface, the formable material is molded into three dimensional objects, which are extruded out of the back of the truck by a paddle wheel. The toy recycling truck has one or more compartments for book molds, which may be used to pre-mold the formable material into replicas of recyclable objects, such as bottles and cans. The truck further has a recycle bin that attaches to lift arms. The recycle bin can be filled with the pre-molded or unmolded formable material and lifted on rotating lift arms by pulling on the exhaust pipes. When the recycle bin is lifted high enough, it rotates forward toward the top of the truck and dumps the load into the truck's storage bin. A door hinged to the back of the truck is then closed, which pushes the formable material through a molding extruder. The molding extruder in the described embodiment has adjacent cylindrical rollers with symmetrically placed inset molds that rotate toward each other. As the formable material is pushed through the rotating rollers while the truck is rolling, the formable material, which may have been a bottle or a can, is reshaped into another figure, such as a fishbone, an insect or a mouse. The adjacent cylindrical rollers, the paddle wheel, and a wheel of the toy truck are connected by a gear mechanism that turns the rollers when the wheel turns during truck movement. A safety feature prevents the adjacent cylindrical rollers from turning if the truck is rolled with the door open.

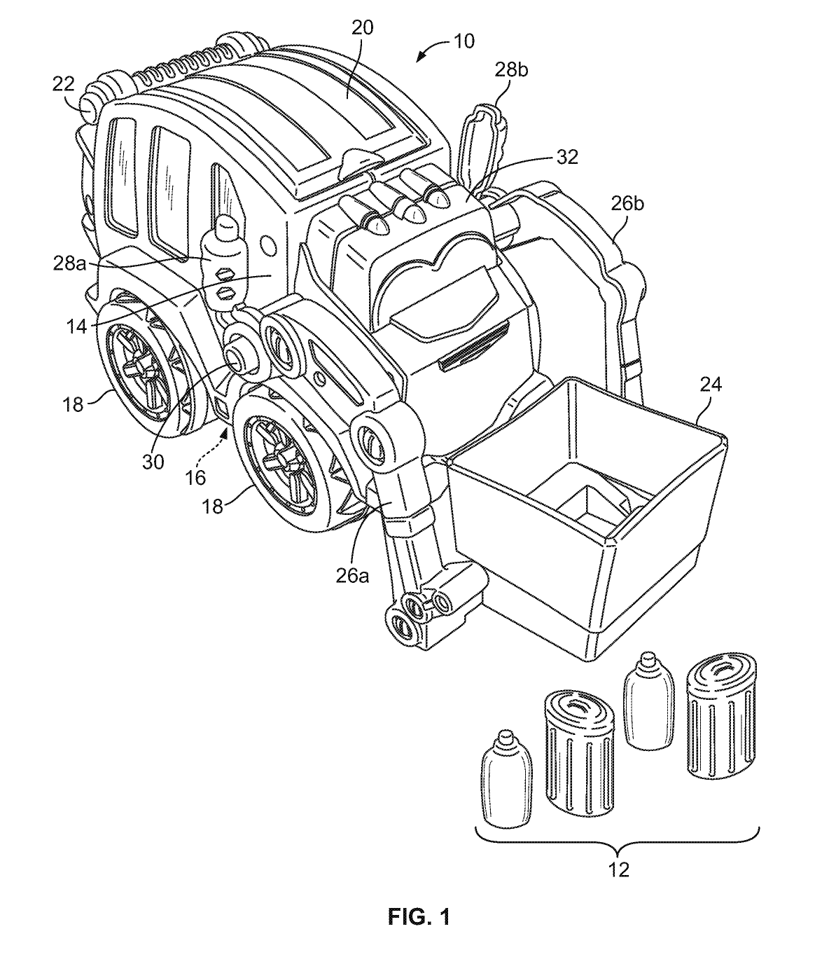

FIG. 1 shows a side elevation view of a toy recycling truck 10 and recyclable figures made from a formable material 12. The truck 10 has a plastic housing 14 in the shape of a recycling truck. In the described embodiments, the housing is made of plastic, although other materials may be used. A chassis 16, which includes four wheels 18, is attached to housing 14. One or more of the wheels 18 is in mechanical communication with a gear mechanism, which is described below as a system of four gears, such that movement initiated in the one or more wheels 18 causes movement in the gear mechanism. A door 20 is hingedly attached to the housing 14 by a door hinge 22 at the back of the truck 10. A recycle bin 24 is rotatably connected to lift arms 26a-b, with each lift arm 26 pivotably attached to and made part of the housing 14 at the lift arm hinge 30. The truck 10 has exhaust pipes 28a-b, which, in the described embodiment, are attached to the lift arms 26a-b at each lift arm hinge 30 so that pulling back on the exhaust pipes 28a-b will rotate the lift arms 26a-b upward. The recycle bin 24 is rotatably connected to lift arms 26a-b by resting some part of the recycle bin 24 onto a connecting part on the lift arms 26a-b assembly. The described toy recycling truck further provides a book mold 32 and a compartment for storing the book mold 32. The book mold 32 may be used to pre-form three dimensional objects from the formable material 12 as shown.

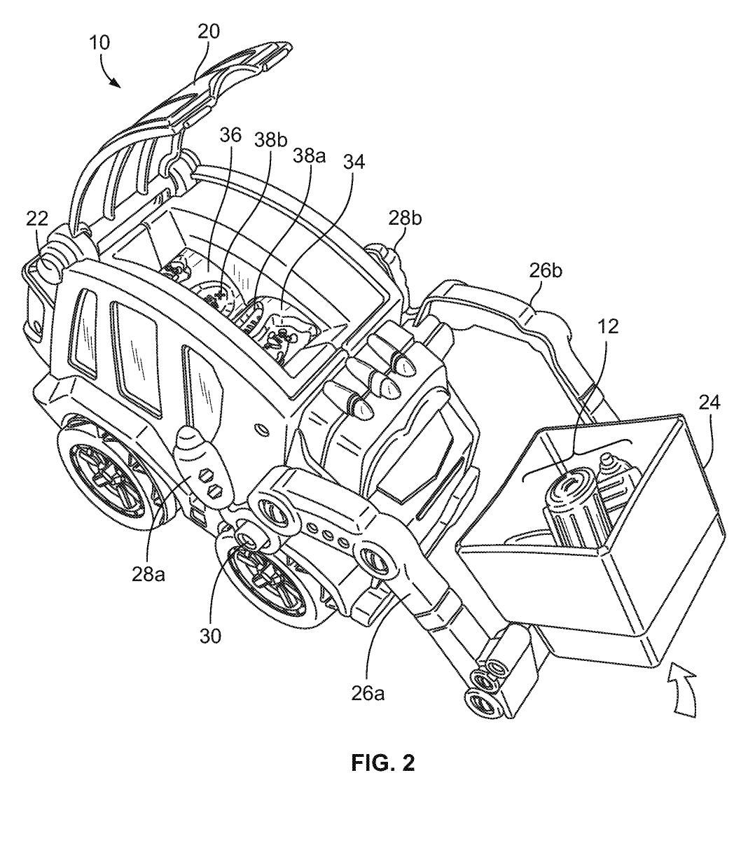

FIG. 2 shows a side elevation view of the toy recycling truck 10 with the top door 20 open and the recycle bin 24 moving towards truck's storage bin. In FIG. 2, the exhaust pipes 28a-b are pulled back and rotated relative to the lift arm hinge 30. As a result of the exhaust pipes 28a-b being pulled back, the lift arms 26a-b rotate upward around the lift arm hinges 30. This causes the recycle bin 24 to be lifted with the formable material 12 toward the truck's storage bin.

As shown in FIG. 2, the door 20 rotates along a door hinge 22 at the back of the truck 10. The open door 20 exposes the first cylindrical roller 34 and the second cylindrical roller 36. The first cylindrical roller 34 and the second cylindrical roller 36 are adjacently aligned so that they are able to rotate toward each other. Symmetrically aligned molds 38a-b are inset into the first cylindrical roller 34 and the second cylindrical roller 36 and positioned to receive the formable material 12. The directional arrow in FIG. 2 shows that as the lift arms 26a-b continue to rotate upward, the recycle bin 24 moves toward the storage bin, where it will dump the formable material 12 onto first cylindrical roller 34 and the second cylindrical roller 36 and the corresponding symmetrically aligned molds 38a-b.

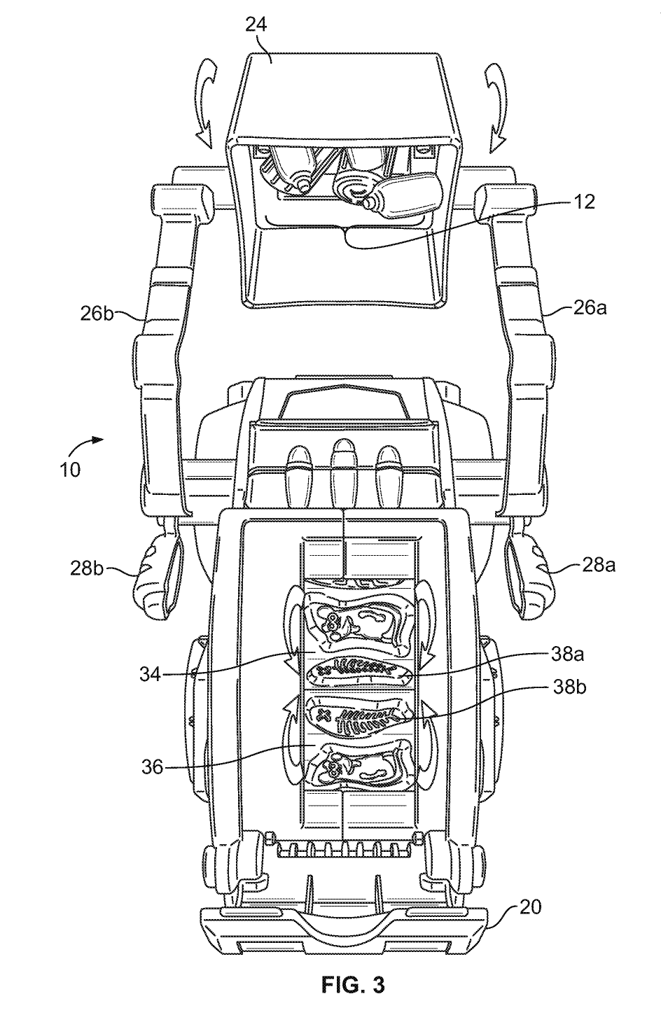

FIG. 3 shows an overhead view the toy recycling truck 10 with the first cylindrical roller 34 and the second cylindrical roller 34 moving and with the recycle bin 24 rotating toward the truck's storage bin. As the exhaust pipes 28a-b continue to move back, the lift arms 26a-b will continue to rise and move the recycle bin 24 and formable material 12 in an upward arc toward the truck's storage bin. Once the lift arms 26a-b reach a point above the truck's storage bin, the recycle bin 24 will rotate forward, as shown by the arrows, and dump the formable material 12 into the truck's storage bin and on top of the first cylindrical roller 34 and the second cylindrical roller 34 and the corresponding symmetrically aligned molds 38a-b. In FIG. 3, the first cylindrical roller 34 and the second cylindrical roller 34 are shown rotating toward each other and the door 20 is shown open. In a described embodiment, a safety feature may be added to prevent the first cylindrical roller 34 and the second cylindrical roller 34 from turning when the door 20 is open. This prevents a child from catching his or her finger between the first cylindrical roller 34 and the second cylindrical roller 34. Additionally, having the door 20 closed improves functioning because the door 20 is used to push the formable material 12 into the symmetrically aligned molds 38a-b. Then, as the first cylindrical roller 34 and the second cylindrical roller 34 rotate, the symmetrically aligned molds 38a-b force the formable material 12 into a single three-dimensional object.

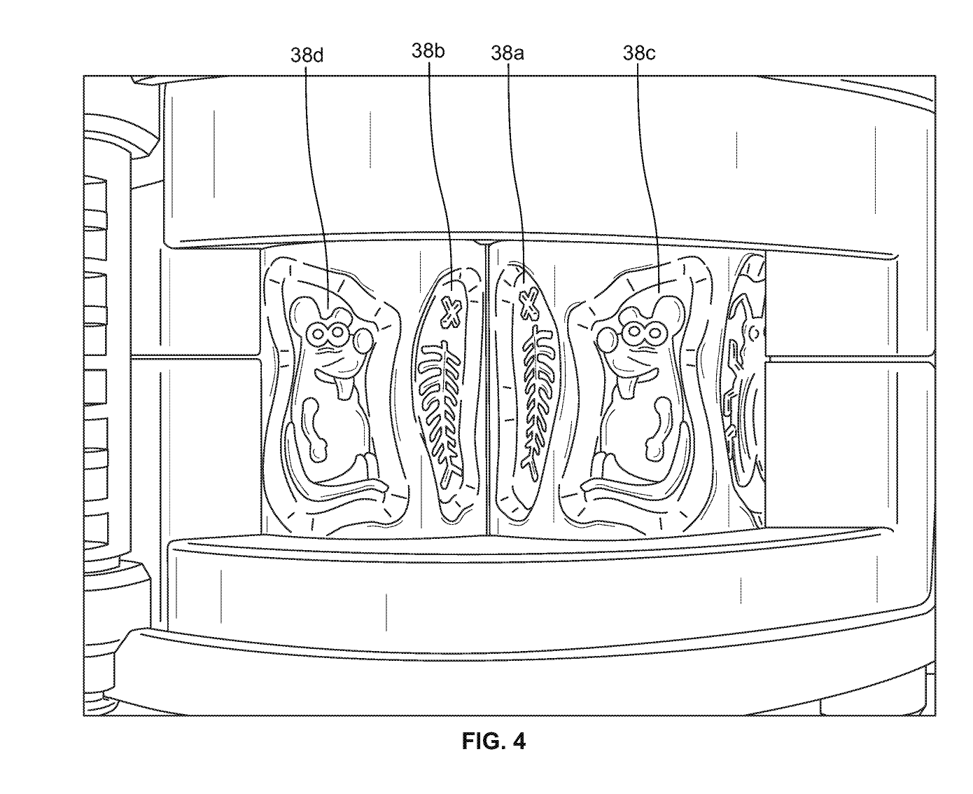

FIG. 4 shows an overhead close up view of symmetrically aligned molds 38a-d inset into the first cylindrical roller 34 and the second cylindrical roller 36. This figure clearly shows how when the first cylindrical roller 34 and the second cylindrical roller 36 rotate toward each other, the symmetrically aligned molds 38a-b come together and, when filled with a formable material 12, press the formable material 12 into a three dimensional object. In the case of symmetrically aligned molds 38a-b, the three dimensional object is a fishbone. After the fishbone is released from the exit, the first cylindrical roller 34 and the second cylindrical roller 36 continue to rotate toward each other. The symmetrically aligned molds 38c-d come together and, when filled with a formable material 12, press the formable material 12 into a three dimensional object. In the case of symmetrically aligned molds 38c-d, the three dimensional object is a mouse.

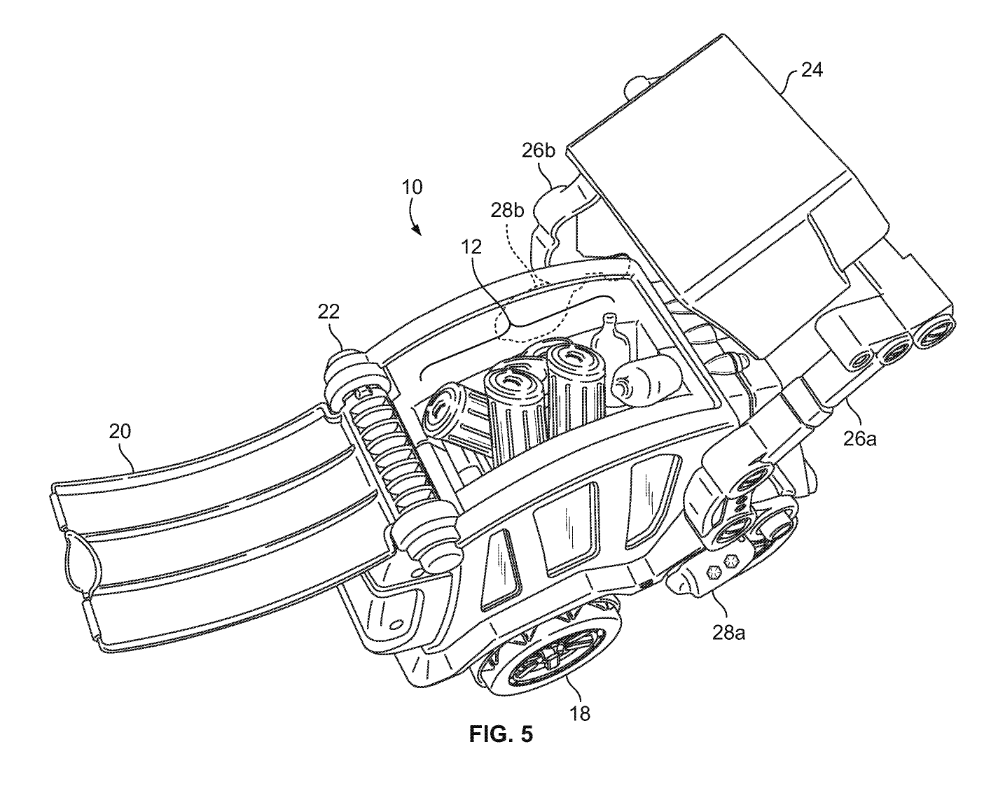

FIG. 5 shows a side elevation view of the toy recycling truck 10 with the storage bin filled with recyclable figures made from a formable material 12. The exhaust pipes 28a-b have been pulled back as far as possible, moving the lift arms 26a-b upward as far as the lift arms 26a-b will go. At that highest point, the recycle bin 24 rotates forward and dumps the formable material 12 into the truck's storage bin. In FIG. 5 the door 20 is shown fully open on the door hinge 22. In a described embodiment, when the door 20 is fully open on the door hinge 22, the wheel 18 is disengaged from the gears that drive the rollers. This prevents a child from catching a finger between the rollers.

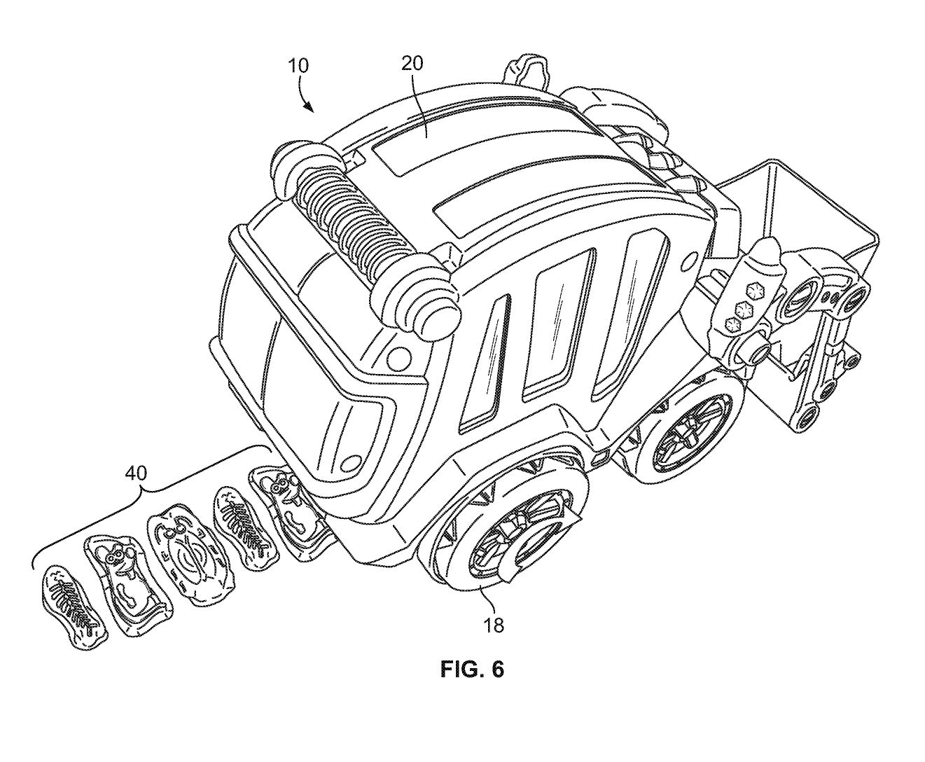

FIG. 6 shows a side elevation view of the toy recycling truck 10 extruding molded objects 40 from the back of the truck 10. The door 20 is shown closed and the wheel 18 is shown moving forward. In a described embodiment with the aforementioned safety feature, because the door 20 is shut, the wheel 18 is engaged with the gears attached to the rollers and the paddle wheel. The result is that extruded molded objects 40 will be expelled from the back of the truck 10.

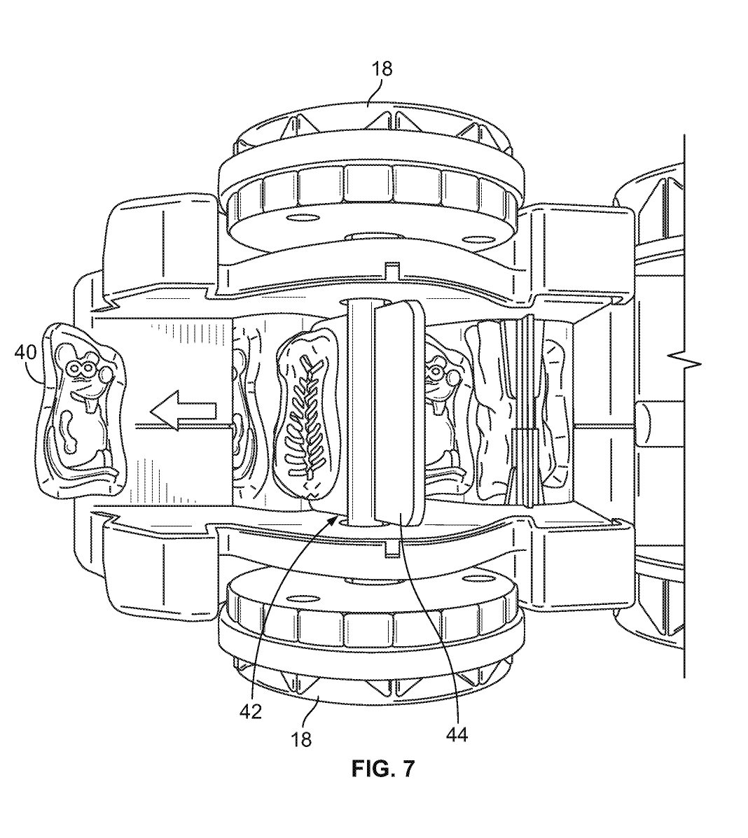

FIG. 7 shows a bottom perspective view with the paddle wheel 42 extruding the molded objects 40. This figure shows a described embodiment with the wheels 18 sharing an axle with the paddle wheel 42. As the wheels 18 move forward, the paddle wheel 42 turns and a paddle 44 extrudes a molded FIG. 40 from the mold as the two halves of the mold separate.

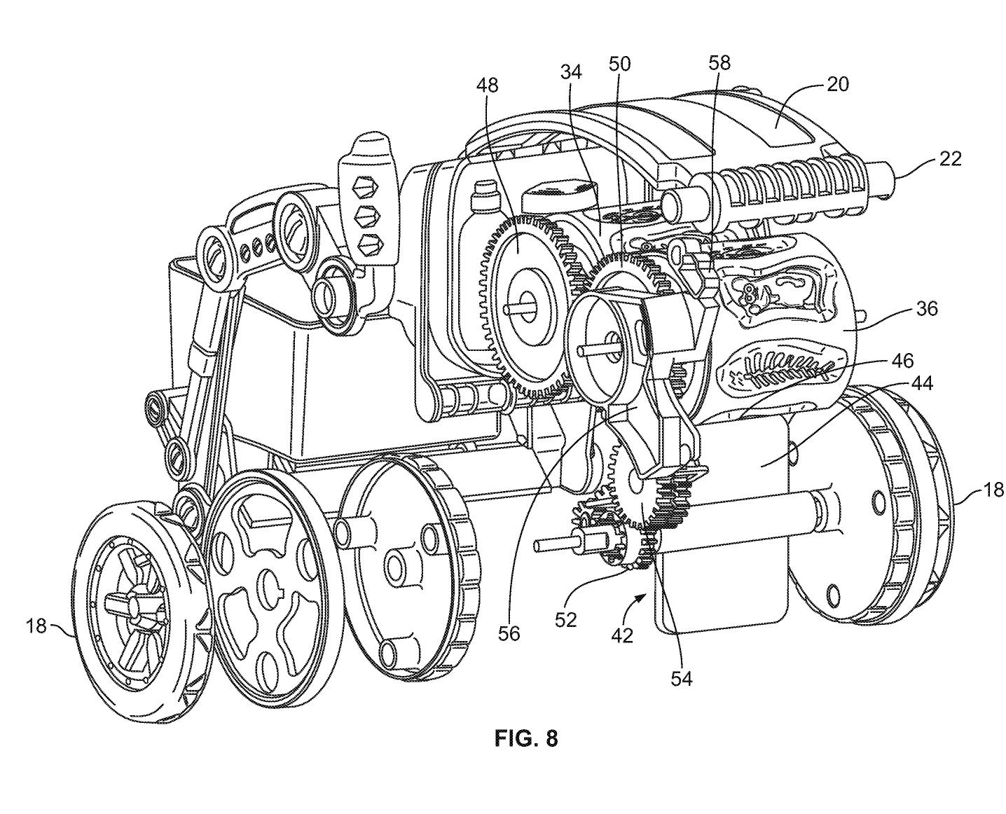

FIG. 8 shows a perspective view of the connections between the first cylindrical roller 34, the second cylindrical roller 36, the gear mechanism, the paddle wheel 42, the door 20, and the door-triggered safety feature. A first gear 48 is shown rotatably connected to the first cylindrical roller 34, and a second gear 50 is shown rotatably connected to the second cylindrical roller 36. The first gear 48 and the second gear 50 are engaged so that when one of the first gear 48 and second gear 50 is turned, both the first gear 48 and second gear 50, as well as the first cylindrical roller 34 and the second cylindrical roller 36, will rotate toward each other. In the shown described embodiment, a third gear 52 is shown coaxially placed with the paddle wheel 42, indicating that in this embodiment, the third gear 52 and the paddle wheel 42 turn together. The third gear is rotatably connected to a wheel 18 and aligned in the same vertical plane as the first gear 48 and the second gear 50. Other arrangements are possible. Note that as the paddle wheel 42 turns, each paddle 44 passes the exit 46 from between the first cylindrical roller 34 and the second cylindrical roller 36, where the paddle 44 extrudes any released molded figure from the exit 46 and expels it from the rear of the truck 10.

Also in FIG. 8, a fourth gear 54 is shown engageably situated between the second gear 50 and the third gear 52. However, in the described embodiment, the fourth gear 54 can be in two positions depending on whether the door 20 is open or closed. When the door 20 is closed, the fourth gear 54 is engaged with the second gear 50 and the third gear 52 so that when the wheel 18 turns forward, the third gear 52 turns the fourth gear 54, the fourth gear 54 turns the second gear 50, and the second gear 50 turns the first gear 48. When the door 20 is open, the fourth gear 54 is disengaged from the second gear 50 and the third gear 52 so that when the wheel 18 turns forward, the third gear 52 neither turns the second gear 50 nor the fourth gear 54. Thus, neither the first gear 48 nor the second gear 50 turns when the door 20 is open. This safety feature is accomplished using a support 56 and a lever 58. The support 56 is attached to the fourth gear 54 and moveably mounted to one of the second cylindrical roller 36 and the housing so that the support 56 may be moved to engage and disengage the fourth gear 54 from the second gear 50 and the third gear 52. The lever 58 is pivotably mounted to the housing so that when the door 20 is closed, the lever 58 pivots into the support 56 and engages the fourth gear 54 with the second gear 50 and the third gear 52. When the door 20 is open, the lever 58 retreats from the support 56, and the support 56 moves and disengages the fourth gear 54 from the second gear 50 and the third gear 52. As will be shown in the next two figures, a protrusion on the door hinge 22 pushes the lever 58 into the support 56 when the door 20 is closed, and the lever 58 releases the support 56 when the door 20 is open. In turn, when the lever 58 moves into the support 56, the fourth gear 54 engages with the second gear 50 and the third gear 52, and when the lever 58 moves away from the support 56, the fourth gear 54 disengages from the second gear 50 and the third gear 52.

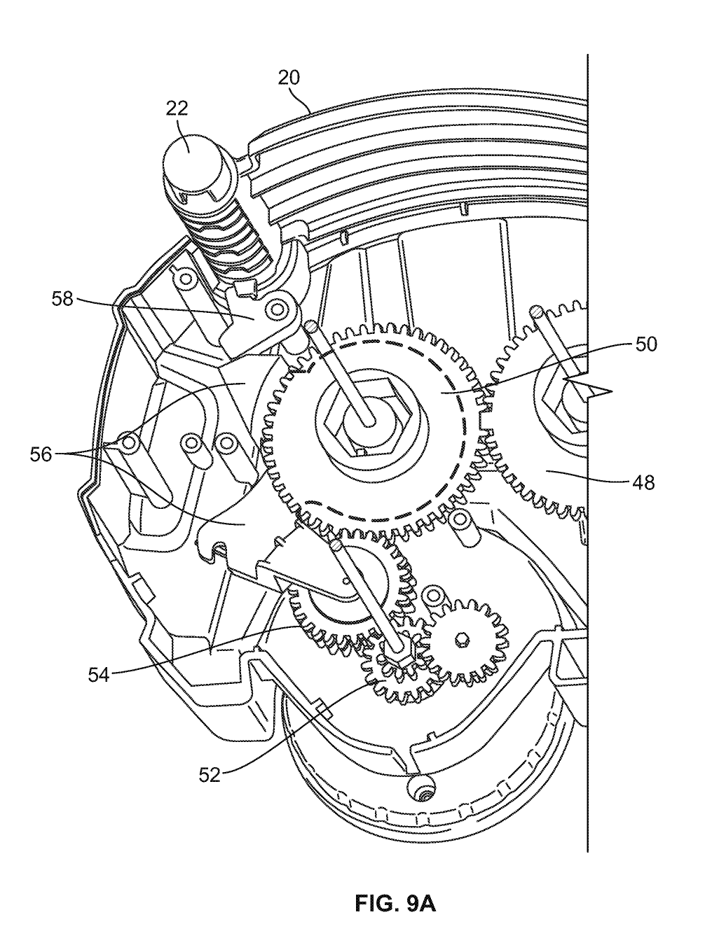

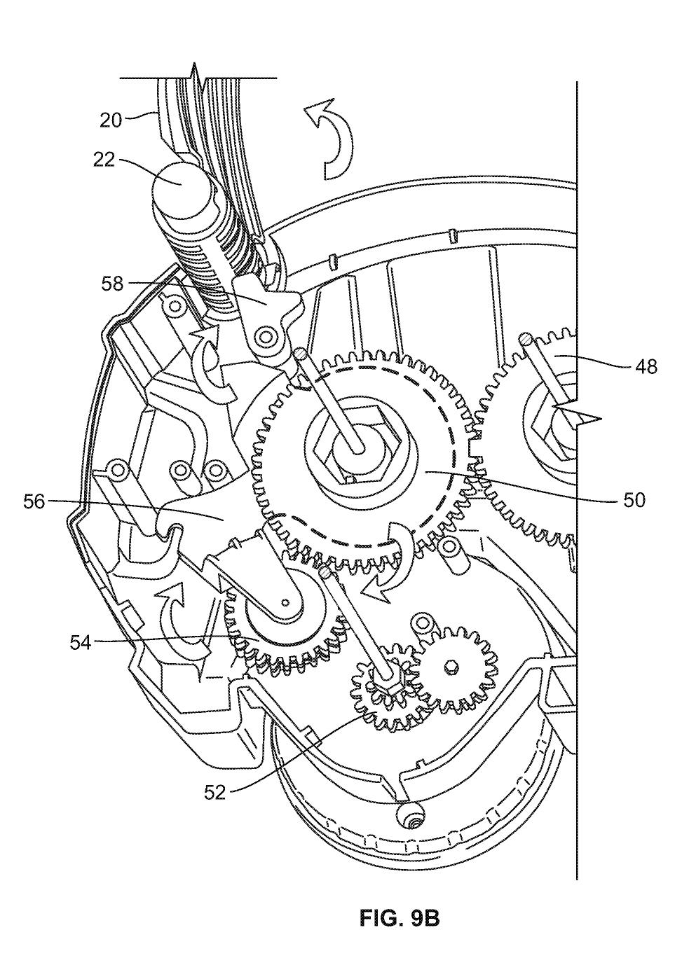

FIG. 9A shows a close up view of the interaction between the gear mechanism and the door-triggered safety feature with the door 20 closed and the gears engaged. As always, the first gear 48 and the second gear 50 and engaged, and movement of one of the gears will move the other gear. The door 20 is shown closed, and the door hinge 22 is turned so that a protrusion on the door hinge 22 pushes against the lever 58. The lever 58, in turn, pivots into the support 56, which engages the fourth gear 54 with the second gear 50 and the third gear 52. Thus, when a wheel turns the third gear 52, the first gear 48 and the second gear 50 will turn toward each other.

FIG. 9B shows a close up view of the interaction between the gear mechanism and the door-triggered safety feature with the door 20 open and the gears disengaged. As always, the first gear 48 and the second gear 50 and engaged, and movement of one of the gears will move the other gear. The door 20 is shown open, and the door hinge 22 is turned so that a protrusion on the door hinge 22 is moved away from the lever 58. The lever 58, in turn, pivots away from the support 56, which disengages the fourth gear 54 from the second gear 50 and the third gear 52. Thus, when a wheel turns the third gear, 52 the first gear 48 and the second gear 50 will not turn.

The above-described embodiment is not meant to limit the scope of the amended claims. In a more general sense regarding other embodiments of toy trucks, the amended claims present embodiments of toy trucks that extrude formable materials and have a housing, a first opening in the housing, a second opening in the housing, and a molding extruder. The molding extruder includes first, a molding device mounted within the housing and accessible through the first opening having an entry that receives a formable material, a mold in communication with the entry that receives and shapes the formable material into a three-dimensional object and an exit in communication with the mold that releases the three-dimensional object, and, second, an expeller in communication with the exit of the molding device that receives the three-dimensional object and expels it through the second opening. Thus, in the above-described embodiment of the recycling truck, the housing was shaped like a recycling truck, the first opening was the door, the second opening was the back end of the truck, and the molding extruder had the two cylindrical rollers with inset molds as the molding device and the paddle wheel as the expeller.

While the present inventions have been illustrated by a description of various embodiments and while these embodiments have been set forth in considerable detail, it is intended that the scope of the inventions be defined by the appended claims. It will be appreciated by those skilled in the art that modifications to the foregoing preferred embodiments may be made in various aspects. It is deemed that the spirit and scope of the inventions encompass such variations to be preferred embodiments as would be apparent to one of ordinary skill in the art and familiar with the teachings of the present application.

What is claimed is:

1. An apparatus for shaping and extruding formable material comprising:
a first cylindrical roller adjacently aligned to a second cylindrical roller, each roller rotatable toward the other and comprising symmetrically aligned molds inset into the first cylindrical roller and the second cylindrical roller and positioned to receive and form a formable material into a three-dimensionally shaped object and to release the object formed from the formable material in the common direction of the rotatable rollers when the symmetrically aligned molds separate during rotation;
a rotatable paddle wheel comprising one or more paddles and aligned so that as the paddle wheel rotates, the one or more paddles are juxtaposed where the rotatable rollers separate from the symmetrically aligned molds and release the object formed from the formable material; and
a gear mechanism in mechanical communication with the first cylindrical roller, the second cylindrical roller and the paddle wheel such that the gear mechanism synchronizes the movement of the first cylindrical roller, the second cylindrical roller and the paddle wheel so that the one or more paddles extrude the object formed from the formable material in the tangential direction of the rotation of the paddle.

2. The apparatus recited in claim 1 further comprising a housing surrounding the first cylindrical roller, the second cylindrical roller, the symmetrically aligned molds, the paddle wheel and the gear mechanism.

3. The apparatus recited in claim 2 further comprising a compartment in the housing for holding a three-dimensional book mold for shaping the formable material.

4. The apparatus recited in claim 2 wherein the housing is shaped as a toy truck.

5. The apparatus recited in claim 2 further comprising a chassis having one or more wheels in mechanical communication with the gear mechanism such that movement initiated in the one or more wheels causes movement in the gear mechanism, the first cylindrical roller, the second cylindrical roller, the symmetrically aligned molds and the paddle wheel.

6. The apparatus recited in claim 5 wherein the first cylindrical roller, the second cylindrical roller and the symmetrically aligned molds are exposable through a first opening in the top of the housing and the paddle wheel is exposed through a second opening in the back of the housing.

7. The apparatus recited in claim 6 further comprising a door covering the first opening that upon closing pushes formable material between the first cylindrical roller and the second cylindrical roller.

8. The apparatus recited in claim 7 further comprising the door covering the first opening in mechanical communication with the gear mechanism such that when the door is closed and covers the first opening, the first cylindrical roller and the second cylindrical roller rotate in response to movement of the gear mechanism and when the door is open the first cylindrical roller and the second cylindrical roller do not rotate.

9. The apparatus recited in claim 8 further comprising:
the gear mechanism further comprising:
a first gear rotatably connected to the first cylindrical roller;
a second gear rotatably connected to the second cylindrical roller and engaged with the first gear;
a third gear rotatably connected to a wheel and aligned in the same vertical plane as the first gear and the second gear; and
a fourth gear engageably situated between the second gear and the third gear;
a support attached to the fourth gear and moveably mounted to one of the second cylindrical roller and the housing so that the support may be moved to engage and disengage the fourth gear from the second gear and the third gear; and
a lever pivotably mounted to the housing so that when the door is closed the lever pivots into the support and engages the fourth gear with the second gear and the third gear and when the door is open the lever retreats from the support and the support moves and disengages the fourth gear from the second gear and the third gear;

10. The apparatus recited in claim 6 further comprising a bin rotatably connected to the housing such that it may be filled with a formable material and rotated to drop the formable material into the first opening.

11. A toy truck that shapes and extrudes formable material comprising:
a housing;
a first opening in the housing;
a second opening in the housing;
a molding extruder comprising:
a molding device mounted within the housing and accessible through the first opening comprising an entry that receives a formable material, a mold in communication with the entry that receives and shapes the formable material into a three-dimensional object and an exit in communication with the mold that releases the three-dimensional object; and
an expeller in communication with the exit of the molding device that receives the three-dimensional object and expels it through the second opening.

12. The toy truck recited in claim 11 further comprising a compartment in the housing for holding a three-dimensional book mold for shaping the formable material.

13. The toy truck recited in claim 11 further comprising a bin rotatably connected to the housing such that it may be filled with a formable material and rotated to drop the formable material into the first opening.

14. The toy truck recited in claim 11 wherein the molding extruder further comprises:
the molding device further comprising a first cylindrical roller adjacently aligned to a second cylindrical roller, each roller rotatable toward the other and comprising symmetrically aligned molds inset into the first cylindrical roller and the second cylindrical roller and positioned to receive and form a formable material into a three-dimensionally shaped object and to release the object formed from the formable material in the common direction of the rotatable rollers when the symmetrically aligned molds separate during rotation;
the expeller further comprising a rotatable paddle wheel comprising one or more paddles and aligned so that as the paddle wheel rotates, the one or more paddles are juxtaposed where the rotatable rollers separate from the symmetrically aligned molds and release the object formed from the formable material; and
a gear mechanism in mechanical communication with the first cylindrical roller, the second cylindrical roller and the paddle wheel such that the gear mechanism synchronizes the movement of the first cylindrical roller, the second cylindrical roller and the paddle wheel so that the one or more paddles extrude the object formed from the formable material in the tangential direction of the rotation of the paddle wheel.

15. The toy truck recited in claim 14 further comprising a chassis having one or more wheels in mechanical communication with the gear mechanism such that movement initiated in the one or more wheels moves the gear mechanism and activates the molding extruder.

16. The toy truck recited in claim 11 further comprising a door covering the first opening that upon closing pushes formable material into the molding device.

17. The toy truck recited in claim 16 further comprising the door covering the first opening in mechanical communication with the gear mechanism such that when the door is closed the gear mechanism engages the molding device and allows the molding device to mold the formable material and when the door is open the gear mechanism disengages from the molding device and prevents the molding device from shaping the formable material.

18. The toy truck recited in claim 17 further comprising:
the gear mechanism further comprising:
a first gear rotatably connected to the molding device;
a second gear rotatably connected to the molding device and engaged with the first gear;
a third gear rotatably connected to a wheel and aligned in the same vertical plane as the first gear and the second gear; and
a fourth gear engageably situated between the second gear and the third gear;
a support attached to the fourth gear and moveably mounted to one of the molding device and the housing so that the support may be moved to engage and disengage the fourth gear from the second gear and the third gear; and
a lever pivotably mounted to the housing so that when the door is closed the lever pivots into the support and engages the fourth gear with the second gear and the third gear and when the door is open the lever retreats from the support and the support moves and disengages the fourth gear from the second gear and the third gear;

19. A method for using a toy truck to shape and extrude formable material comprising:
aligning a first cylindrical roller adjacent to a second cylindrical roller, each roller rotatable toward the other;
insetting molds into the first cylindrical roller and the second cylindrical roller;
symmetrically aligning the molds to receive and form a formable material into a three-dimensionally shaped object;
aligning a rotatable paddle wheel comprising one or more paddles so that as the paddle wheel rotates the one or more paddles are juxtaposed where the rotating rollers separate from the symmetrically aligned molds and release the object formed from the formable material;
synchronizing the movement of the first cylindrical roller, the second cylindrical roller and the paddle wheel using a gear mechanism;
encasing the first cylindrical roller, the second cylindrical roller, the molds, the paddle wheel and the gear mechanism in a toy truck shaped housing with a first opening and a second opening so that the first cylindrical roller, the second cylindrical roller and the molds are exposed through the first opening and the paddle wheel is exposed through the second opening;
attaching a chassis with wheels to the housing and attaching at least one of the wheels to the gear mechanism such that movement initiated in the one or more wheels causes movement in the gear mechanism, the first cylindrical roller, the second cylindrical roller, the symmetrically aligned molds and the paddle wheel;
rotating the first cylindrical roller and the second cylindrical roller by rolling the toy truck;
feeding formable material between the rotating rollers and forming the object in the molds;
releasing the object formed from the formable material in the common direction of the rotatable rollers when the symmetrically aligned molds separate during rotation; and
extruding the object formed from the formable material in the tangential direction of the rotation of the paddle.

20. The method for using a toy truck to shape and extrude formable material recited in claim 19 further comprising:
attaching a door to the first opening;
opening the door and exposing the molds;
disengaging the gear mechanism;
feeding formable material into the molds;
closing the door;
engaging the gear mechanism when the door is closed;
rolling the truck; and
extruding three-dimensionally shaped objects.
